(19) United States
(12) Patent Application Publication
(10) Pub. No.: US 2003/0234051 A1
(43) Pub. Date: Dec. 25, 2003

(54) Flow controlling magnetic valve

(75) Inventors: Ari Toivonen, Eurajoki (FI); Jukka Alhola, Eurajoki (FI)

Correspondence Address: YOUNG & THOMPSON, 745 SOUTH 23RD STREET 2ND FLOOR, ARLINGTON, VA, 22202

(73) Assignee: ORAS OY, RAUMA (FI)

(21) Appl. No.: 10/443,872

(22) Filed: May 23, 2003

(30) Foreign Application Priority Data
Jun. 20, 2002 (FI) 20021210

(51) Int. Cl. F16K 37/00

(52) U.S. Cl. 137/554

(57) ABSTRACT

The invention relates to a material-flow controlling magnetic valve (1), comprising a material inlet connection (3), an outlet connection (4), at least one sealing surface (12), and an element (6) movable relative to the sealing surface (12), which, in itself or through the use of a blocking member (11) movable together therewith, is in cooperation with said sealing surface (12) establishing a port (15) between the inlet connection (3) and the outlet connection (4), the element (6) having its movement controlled by means of at least one solenoid (10), and that a housing (5), established in the valve (1) and defined by the moveable element (6), is connected by way of a first flow channel (7) controlled by the first solenoid (8) with a material supply side and by way of a second flow channel (9) controlled by a second solenoid (10) with a material discharge side, wherein, by setting the housing's (5) volume and at the same time the element's (6) position as desired by means of the solenoids (8, 10), the control port (15) is established between the inlet and outlet connections (3, 4).

The invention relates to stepless flow control. Specifically, it involves a material-flow controlling magnetic valve implemented by two solenoids.

The publication WO 97/04260 discloses a prior known solution, wherein a flow through a channel is opened or closed by means of an electromagnet or a permanent magnet. A solenoid is used for operating a valve-opening lever from one end position to the other, the valve being either open or shut. Closing and opening are effected to full extent in a single operation, i.e. the valve is either fully open or fully shut.

On the other hand, the publication U.S. Pat. No. 5,469,886 discloses a solution, wherein the opening and closing of a flow channel are effected by means of two solenoids. The purpose of two solenoids is to improve operating reliability of the mechanism. In the solution disclosed in the publication U.S. Pat. No. 5,469,886, the flow channel is opened or closed to full extent in a single operation the same way as set forth in the above-cited publication WO 97/04260.

It is an object of this invention to provide a continuously controlled flow through a magnetic valve, said flow being controllable and sustainable as a constant of desired volume.

In order to accomplish this, a mechanism of the invention is characterized in that two solenoids are used for regulating a liquid volume present in the housing of a magnetic valve and at the same the housing volume, the flow occurring through the magnetic valve being controlled by means of said liquid volume.

Embodiments of the invention are characterized by what is set forth in the appended claims.

The invention will now be described in more detail by way of example with reference to the accompanying figures, in which

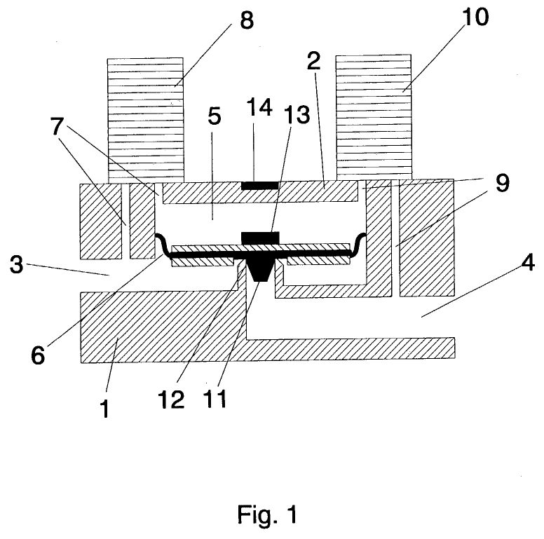

FIG. 1 shows a cross-section in principle for a magnetic valve without any flow passing through the magnetic valve

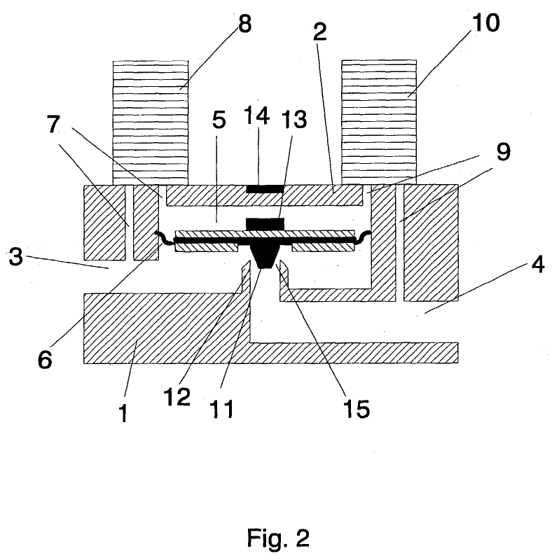

FIG. 2 shows a cross-section in principle for a magnetic valve with a constant flow of desired volume passing through the magnetic valve,

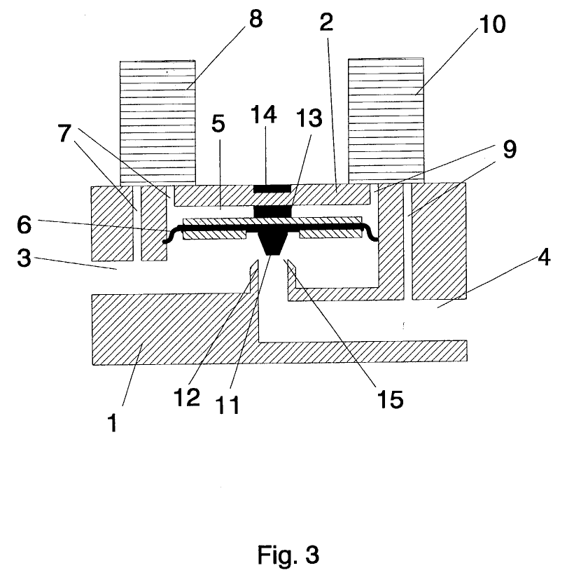

FIG. 3 shows a cross-section in principle for a magnetic valve with a maximum flow passing through the magnetic valve, and

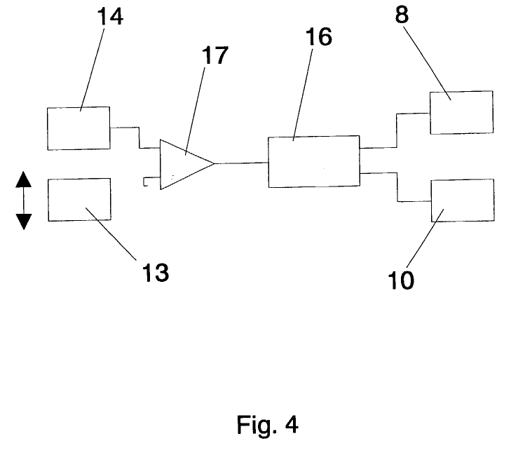

FIG. 4 shows a magnetic valve control in a diagrammatic view.

FIG. 1 shows a magnetic valve 1 in cross-section, said magnetic valve comprising a body 2. The body 2 is provided with an inlet connection 3 for an inbound liquid or gaseous substance, such as water, for example, as well as with an outlet connection 4 for discharging the substance from the magnetic valve 1. The magnetic valve 1 is provided with a housing 5, one wall of which is constituted by a movable element 6. The movable element 6 is preferably constituted at least partially by a flexible diaphragm for regulating a flow passing through the magnetic valve 1. The housing is supplied with a substance flowing through the magnetic valve 1 from the inlet connection 3 by way of an inlet channel 7. The inlet channel 7 is adapted to be closed and opened by means of a solenoid 8. Respectively, the housing 5 can be drained of a substance by way of an outlet channel 9 to the magnetic valve's outlet connection 4. The regulation of a flow occurring through the outlet channel 9 is effected by means of a solenoid 10. The solenoid 10 can be used either for opening or closing the outlet channel 9. The movable element 6 is preferably provided with a blocking member 11, which descends towards a sealing surface 12 present in the magnetic valve's 1 body 2 as the amount of substance in the housing 5 is increased, thus augmenting the housing volume. When the substance volume in the housing 5 is increased sufficiently, the blocking member 11 descends fully against the magnetic valve's 1 sealing surface 12 to stop the flow completely, the magnetic valve being in a closed condition as indicated in FIG. 1.

In addition, the blocking member 11 is preferably fitted with a permanent magnet 13, as well as with a magnetic field sensor 14 on the opposite side of the housing 5 for monitoring the position of the movable element 6 and simultaneously that of the blocking member 11 in order to control or regulate a flow passing through the magnetic valve 1, as described next in more detail with reference to FIG. 2.

In FIG. 2, the housing 5 has been drained of some substance by having the solenoid 10 open the outlet channel 9 for a moment. Consequently, a pressure existing on the inlet connection's 3 side of the magnetic valve 1 shifts the movable element 6 to diminish a volume of the housing 5 and at the same time disengages the blocking member 11 from the sealing surface 12 present in the magnetic valve body 2. Thus, material is able to flow through a port 15 established between the blocking member 11 and the valve's sealing surface 12. The port's 15 size is adjusted by means of the discharged volume of a substance present in the housing 5 effected by the solenoid 10 through the outlet channel 9 or by means of the volume of substance supplied by the solenoid 8 through the inlet channel 7. The magnitude of pressure existing on the inlet connection's 3 side of the magnetic valve 1 has also an effect on the flow rate of a material volume both in the inlet channel 7 and in the outlet channel 9. In order to compensate for flow rate variations in the channels 7 and 9, possibly caused by pressure fluctuations existing on this inlet connection's 3 side, the movable element 6 and/or the blocking member 11 are/is preferably provided with a permanent magnet 13. The permanent magnet 13 can be mounted directly on the movable element 6 or, optionally, it can be fitted for example inside the blocking member 11. Respectively, on the side of the housing 5, opposite to the permanent magnet 13, is mounted a magnetic field sensor 14. The magnetic field sensor 14 and the permanent magnet 13 enable a simple control circuit to be established, by means of which it is possible to precisely control the volume of material or substance present in the housing 5 by opening, as necessary, the inlet channel 7 or the outlet channel 9 with the solenoids 8 and 10, respectively. While adjusting a position of the permanent magnet 13 in relation to the magnetic field sensor 14, the volume of a substance present in the housing 5 is used at the same time for controlling a flow rate passing through the magnetic valve 1 by making the port 15 smaller or larger. The permanent magnet's 13 position is monitored by the magnetic field sensor 14 and the information supplied thereby is used by control electronics for controlling the solenoids 8 and 10 and a flow occurring the channels 7 and 9, respectively, until the permanent magnet 13 assumes a desired position in relation to the magnetic field sensor 14 and a desired flow rate through the magnetic valve 1 is accomplished.

FIG. 3 illustrates a condition, in which the magnetic valve 1 is fully open and a material flow through the port 15 is at its maximum. At this time, the housing 5 contains a minimum volume of material and in this condition the permanent magnet 13 is pressed against the housing's 5 top surface to lie as close as possible to the magnetic field sensor 14.

FIG. 4 illustrates operation of the magnetic valve 1 in a block diagram. It shows that the operation of solenoids 8 and 10 is controlled by means of control electronics 16 and sensors, which monitor the position of a movable element 6 constituting at least partially one of the walls of a housing 5 and which preferably comprise a permanent magnet 13 and a magnetic field sensor 14. The mechanism preferably includes also an amplifier 17 between the magnetic field sensor 14 and the control electronics 16.

The magnetic valve 1 may have an internal structure different from that shown in FIG. 1, but the essential feature is that the rate of a flow passing through the magnetic valve by way of the port 15 is controlled by means of the volume of material contained in the housing 5, and that the volume of material present in the housing 5 is monitored by means of the simple sensor system 13 and 14 as well as regulated by means of the solenoids 8 and 10 controlled by the control electronics 16.

Instead of a diaphragm, a volume change of the housing 5 can be optionally effected, for example by means of a sealed piston. In this case, the piston is able to reciprocate in a sleeve consistently with a material volume present in the housing 5, said material volume being regulated as described above. The end of the piston, opposite with respect to the housing 5, is preferably provided with a complementary blocking member 11 pressing against the magnetic valve's 1 sealing surface 12.

On the other hand, one wall of the housing 5 can be completely or partially constituted by a flexible diaphragm, which in itself, without a separate blocking member 11, presses against the sealing surface 12 present in the valve body 2, which sealing surface can also be given a design other than what is shown in FIGS. 1-3. However, in this case the diaphragm is fitted with a permanent magnet 13 for monitoring the diaphragm position.

1. A material-flow controlling magnetic valve (1), comprising a material inlet connection (3), an outlet connection (4), at least one sealing surface (12), and an element (6) movable relative to the sealing surface (12), which, in itself or through the use of a blocking member (11) movable together therewith, is in cooperation with said sealing surface (12) establishing a port (15) between the inlet connection (3) and the outlet connection (4), the element (6) having its movement controlled by means of at least one solenoid (10), in which valve (1) is established a housing (5) defined by the movable element (6) and connected by way of a flow channel (7) with a material supply side and by way of a second flow channel (9), controlled by a second solenoid (10), with a material discharge side, characterized in that, by setting the housing's (5) volume and at the same time the element's (6) position as desired by means of the first flow channel controlled by the first solenoid (8) and the second flow channel (9) controlled by the second solenoid (10), the controlled port (15) is established between the inlet and outlet connections (3, 4), said port (15) being defined by the sealing surface (12) and the blocking member (11) axially movable relative to the sealing surface (12).

2. A magnetic valve (1) as set forth in claim 1, characterized in that the movable element (6) comprises a piston movable in a sleeve, a flexible diaphragm, or a flexible diaphragm provided with a blocking member (11).

3. A magnetic valve (1) as set forth in claim 1, characterized in that the housing (5) is established on the side of the movable element (6), which is opposite to said sealing surface (12).

4. A magnetic valve (1) as set forth in claim 1, characterized in that a sensor system (13, 14), sensing a position of the movable element (6), is connected by way of control electronics (16) with said solenoids (8, 10).

5. A magnetic valve (1) as set forth in claim 4, characterized in that the sensor system comprises a permanent magnet (13), which is mounted on the movable element (6), as well as a magnetic field sensor (14), which is mounted on the magnetic valve's (1) body (2).

6. A magnetic valve (1) as set forth in any of the preceding claims, characterized in that the sealing surface (12) is in a per se known manner annular and that working in cooperation therewith is a tapered blocking member (11) mounted on the movable element (6) and movable axially relative to the annular sealing surface (12).

7. A magnetic valve (1) as set forth in claims 5 and 6, characterized in that the permanent magnet (13) is mounted on the movable element (6) in coincidence with the blocking member (11) or directly on the blocking member (11).
